(19) United States
(12) Patent Application Publication
(10) Pub. No.: US 2023/0336234 A1
(43) Pub. Date: Oct. 19, 2023

(54) FAST BEAM SWITCH

(71) Applicant: Telefonaktiebolaget LM Ericsson (publ), Stockholm (SE)

(72) Inventors: Claes TIDESTAV, Bålsta (SE); Joakim AXMON, Limhamn (SE)

(21) Appl. No.: 18/245,672

(22) PCT Filed: Sep. 23, 2021
(86) PCT No.: PCT/EP2021/076278

§ 371 Date: Mar. 16, 2023

Related U.S. Application Data
(60) Provisional application No. 63/082,269, filed on Sep. 23, 2020.

(51) Int. Cl. H04B 7/06; H04L 5/00

(52) U.S. Cl. CPC H04B 7/06968; H04B 7/0626; H04L 5/0048; H04B 7/063

(57) ABSTRACT

A method, system and apparatus are disclosed. According to some embodiments, a wireless device is provided. The wireless device includes processing circuitry configured to at least temporarily store at least one quasi co-located, QCL, property of at least one reference signal, RS, where the at least one RS is measured and reported while a previous Transmission Configuration Indicator (TCI) state is active, to allow for a TCI state update without having to wait for an occurrence of a reference signal associated with an updated TCI state, and apply a TCI state update based on the at least temporarily stored at least one QCL property of the at least one RS.

### FIELD

The present disclosure relates to wireless communications, and in particular, to a Transmission Configuration Indicator (TCI) state update based on at least one QCL property of a previous reference signal (RS) measurement.

### BACKGROUND

In New Radio (NR, also referred to as 5^{th} Generation (5G)), several synchronization and reference signals (collectively referred to as Sync signals) have been defined. In order to connect to a network or to detect signals from network nodes, a wireless device may need to acquire network synchronization with respect to the relevant nodes or network node(s). Sync signals are used for tuning the frequency reference of the wireless device relative the network/network node, and for finding the timing of the received signal from the network/network node. In NR, the synchronization and access procedure may involve and utilize several signals/configurations described below.

To improve demodulation performance, a wireless device can be configured with a so-called QCL (quasi co-location) relationship between two signals. Two signals that have the same large-scale properties, for instance in terms of Doppler shift/spread, average delay spread, or average delay are said to be quasi co-located (QCL).

The network node can signal to the wireless device that two antenna ports are QCL. If the wireless device knows that two antenna ports are QCL with respect to a certain parameter, the wireless device can estimate that parameter based on one of the antenna ports and use that estimate when receiving the signal over the other antenna port. For instance, if antenna ports A and B are QCL with respect to average delay, the wireless device can estimate the average delay from the signal received at antenna port A and assume that the signal received at antenna port B has the same average delay.

Information about what assumptions can be made regarding QCL may be signaled to the wireless device from the network node. In NR, four types of QCL relations between a source reference signal (RS) and a target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is referred to as spatial QCL. There is no strict definition of spatial QCL, but the general understanding is that if two antenna ports are spatially QCL, the wireless device can use the same Rx beam to receive them. For beam management, the QCL discussion mostly revolves around QCL Type D, but it may also be necessary to convey a Type A QCL relation to the wireless device, so that the wireless device can estimate the relevant parameters.

In NR, the QCL properties are signaled in Transmission Configuration Indicator (TCI) states. One TCI state contains one or two source downlink (DL) RSs, and each source RS is associated with a QCL type.

To derive the relevant QCL properties from one RS, the wireless device would have to be able to receive that RS with sufficient signal strength. As the wireless device moves, the network/network node may then have to update the QCL source that the wireless device uses, as illustrated in FIG. 1 where the wireless device may “hear” or detect different RSs as the wireless device moves.

The QCL source is updated after the wireless device has performed measurements that indicate that a new RS would be a better QCL source. A typical sequence of events is illustrated in the signaling diagram of FIG. 2 where the TCI is updated using MAC CE signaling.

Note that in step e, the wireless device waits for another occurrence of the new QCL source—the SSB that is included in the TCI state signaled in MAC CE. Also note that the TCI state update is almost always preceded by a measurement on the corresponding RS. To perform the measurement, the wireless device performs a channel estimation, and derives the large scale channel properties that are relevant when the RS is used as QCL source.

Similar to Long Term Evolution (LTE, also referred to as 4th Generation (4G)), in NR, a dedicated reference signal has been defined to estimate channel state information. These reference signals are referred to as channel state information reference signal (CSI-RS).

A CSI-RS signal is transmitted on a set of time-frequency resource elements (REs) associated with an antenna port. For channel estimation over a system bandwidth, CSI-RS is typically transmitted over the whole system bandwidth. The set of REs used for CSI-RS transmission is referred to as CSI-RS resource.

The following one or more time-domain behaviors of CSI-RS transmissions may be supported:
Periodic CSI-RS Transmission: CSI-RS is transmitted periodically in certain subframes or slots. This CSI-RS transmission is semi-statically configured using parameters such as CSI-RS resource, periodicity and subframe or slot offset similar to LTE.
Aperiodic CSI-RS Transmission: This is a one-shot CSI-RS transmission that can occur in any subframe or slot. Here, one-shot means that CSI-RS transmission only happens once per trigger. The CSI-RS resources (i.e., the resource element locations which consist of subcarrier locations and OFDM symbol locations) for aperiodic CSI-RS are semi-statically configured. The transmission of aperiodic CSI-RS is triggered by dynamic signaling through physical downlink control channel (PDCCH). The triggering may also include selecting a CSI-RS resource from multiple CSI-RS resources.
Semi-Persistent CSI-RS Transmission: Similar to periodic CSI-RS, resources for semi-persistent CSI-RS transmissions are semi-statically configured with parameters such as periodicity and subframe or slot offset. However, unlike periodic CSI-RS, dynamic signaling may be needed to activate and possibly deactivate the CSI-RS transmission.

Based on measurements performed on the CSI-RS, the wireless device may report the channel state information (CSI) to the network/network node. In NR, three types of CSI reporting may be supported:
Periodic CSI Reporting: CSI is reported periodically by the wireless device. Parameters such as periodicity and subframe or slot offset are configured semi-statically, by higher layer signaling from the network node to the wireless device. Periodic reporting is performed over the Physical Uplink Control Channel (PUCCH);
Aperiodic CSI Reporting: This type of CSI reporting involves a single-shot (i.e., one time) CSI report by the wireless device, which is dynamically triggered by the network node, e.g., by the DCI in PDCCH. Some of the parameters related to the configuration of the aperiodic CSI report are semi-statically configured from the network node to the wireless device but the triggering is dynamic. Aperiodic reporting is performed over the Physical Uplink Shared Channel (PUSCH).
Semi-Persistent CSI Reporting: similar to periodic CSI reporting, semi-persistent CSI reporting has a periodicity and subframe or slot offset which may be semi-statically configured by the wireless device to the wireless device. However, a dynamic trigger from the network node to the wireless device may be needed to allow the wireless device to begin semi-persistent CSI reporting. Semi-persistent reporting can be performed over PUCCH or PUSCH.

With regard to CSI-RS transmission and CSI reporting, one or more of the following combinations may be supported in NR:
For periodic CSI-RS transmission
   Semi-persistent CSI reporting is dynamically activated/deactivated
   Aperiodic CSI reporting is triggered by downlink control information (DCI)
For semi-persistent transmission of CSI-RS,
   Semi-persistent CSI reporting is activated/deactivated dynamically
   Aperiodic CSI reporting is triggered by DCI
For aperiodic transmission of CSI-RS,
   Aperiodic CSI reporting is triggered by DCI
   Aperiodic CSI-RS is triggered dynamically

However, in existing systems, a new TCI state can only be applied when the wireless device has received the RS in the new TCI state another time. This leads to a significantly slower TCI state updates, which may negatively impact performance.

### SUMMARY

Some embodiments advantageously provide methods, wireless devices and network nodes for TCI state update based on at least one QCL property of at least one previous RS measurement such as based on a measurement performed while a previous TCI state is active.

In one or more embodiments, the wireless device stores the QCL properties of a measured reference signal. The network node can then configure the wireless device to directly switch to use the QCL properties of a reference signals without having to wait for a new occurrence of the reference signal. Therefore, one or more embodiments described herein advantageously allow the network node to update the QCL properties, e.g., beam, faster if the wireless device can store the QCL properties that the wireless device derived from a previous measurement.

According to one aspect of the disclosure, a network node configured to communicate with a wireless device is provided. The network node includes processing circuitry configured to trigger, at a wireless device, a Transmission Configuration Indicator, TCI, state update that is based on at least one quasi co-located, QCL, property of at least one reference signal, RS, measured and reported by the wireless device while a previous TCI state is active, as described herein.

According to one or more embodiments of this aspect, the triggering of the TCI state update is associated with the wireless device applying an updated TCI state. According to one or more embodiments of this aspect, the applying of the updated TCI state is configured to occur without having to wait for an occurrence of a reference signal associated with the updated TCI state. According to one or more embodiments of this aspect, the processing circuitry is further configured to receive wireless device capability information indicating that the wireless device is capable of storing information related to the at least one QCL property of at least one RS measurement.

According to one or more embodiments of this aspect, the at least one QCL property includes at least one of power, at least one property associated with a channel state information, CSI, report, signal delay, doppler property and spatial property. According to one or more embodiments of this aspect, the at least one RS is at least one downlink RS, the at least one downlink RS being one of a periodic, semi-persistent and aperiodic RS where the processing circuitry is further configured to receive a channel state information, CSI, report based on the TCI state update where the report is one of a periodic, semi-persistent and aperiodic report.

According to another aspect of the disclosure, a method implemented by a network node that is configured to communicate with a wireless device is provided. A Transmission Configuration Indicator, TCI, state update that is based on at least one quasi co-located, QCL, property of at least one reference signal, RS, measured and reported by the wireless device while a previous TCI state is active is triggered at a wireless device.

According to one or more embodiments of this aspect, the triggering of the TCI state update is associated with the wireless device applying an updated TCI state. According to one or more embodiments of this aspect, the applying of the updated TCI state is configured to occur without having to wait for an occurrence of a reference signal associated with the updated TCI state. According to one or more embodiments of this aspect, wireless device capability information indicating that the wireless device is capable of storing information related to the at least one QCL property of at least one RS measurement.

According to one or more embodiments of this aspect, the at least one QCL property includes at least one of power, at least one property associated with a channel state information, CSI, report, signal delay, doppler property and spatial property. According to one or more embodiments of this aspect, the at least one RS is at least one downlink RS, the at least one downlink RS being one of a periodic, semi-persistent and aperiodic RS, and a channel state information, CSI, report based on the TCI state update is received where the report is one of a periodic, semi-persistent and aperiodic report.

According to another aspect of the disclosure, a wireless device includes processing circuitry configured to: at least temporarily store at least one quasi co-located, QCL, property of at least one reference signal, RS, where the at least one RS is measured and reported while a previous Transmission Configuration Indicator (TCI) state is active, to allow for a TCI state update without having to wait for an occurrence of a reference signal associated with an updated TCI state, and apply a TCI state update based on the at least temporarily stored at least one QCL property of the at least one RS, as described herein.

According to one or more embodiments of this aspect, the at least one QCL property of a plurality of QCL properties associated with the at least one RS is based on a QCL type of the at least one RS. According to one or more embodiments of this aspect, the at least temporarily storing of the at least one QCL property corresponds to storing of the at least one QCL property for a predefined quantity of time. According to one or more embodiments of this aspect, the at least one RS is a plurality of RSs, the at least one QCL property corresponds to a plurality of QCL properties for the plurality of RSs that were measured and reported while the previous TCI is active.

According to one or more embodiments of this aspect, the at least temporarily storing of at least one QCL property associated with the at least one RS is based on a time domain behavior of at least the at least one RS. According to one or more embodiments of this aspect, the processing circuitry is further configured receive a channel state information, CSI, report configuration indicating QCL properties of at least one RS measurement to be reported. According to one or more embodiments of this aspect, the processing circuitry is further configured to transmit wireless device capability information indicating that the wireless device is capable of storing information related to the at least one QCL property of the at least one RS that is measured and reported while the previous TCI state is active.

According to one or more embodiments of this aspect, the at least one QCL property includes at least one of power, at least one property associated with a channel state information, CSI, report, signal delay, doppler property and spatial property. According to one or more embodiments of this aspect, the at least one QCL property corresponds to at least one spatial QCL property. According to one or more embodiments of this aspect, the at least one RS is at least one downlink RS, the at least one downlink RS being one of a periodic, semi-persistent and aperiodic RS where the processing circuitry is configured to transmit a CSI report based on the TCI state update, the report being one of a periodic, semi-persistent and aperiodic report.

According to another aspect of the disclosure, a method implemented by a wireless device is provided. At least one quasi co-located, QCL, property of at least one reference signal, RS, is at least temporarily stored where the at least one RS is measured and reported while a previous Transmission Configuration Indicator (TCI) state is active, to allow for a TCI state update without having to wait for an occurrence of a reference signal associated with an updated TCI state. A TCI state update is applied based on the at least temporarily stored at least one QCL property of the at least one RS.

According to one or more embodiments of this aspect, the at least one QCL property of a plurality of QCL properties associated with the at least one RS is based on a QCL type of the at least one RS. According to one or more embodiments of this aspect, the at least temporarily storing of the at least one QCL property corresponds to storing of the at least one QCL property for a predefined quantity of time. According to one or more embodiments of this aspect, the at least one RS is a plurality of RSs, the at least one QCL property corresponds to a plurality of QCL properties for the plurality of RSs that were measured and reported while the previous TCI is active.

According to one or more embodiments of this aspect, the at least temporarily storing of at least one QCL property associated with the at least one RS is based on a time domain behavior of at least the at least one RS. According to one or more embodiments of this aspect, a channel state information, CSI, report configuration indicating QCL properties of at least one RS measurement to be reported is received. According to one or more embodiments of this aspect, wireless device capability information indicating that the wireless device is capable of storing information related to the at least one QCL property of the at least one RS that is measured and reported while the previous TCI state is active, is transmitted.

According to one or more embodiments of this aspect, the at least one QCL property includes at least one of power, at least one property associated with a channel state information, CSI, report, signal delay, doppler property and spatial property. According to one or more embodiments of this aspect, the at least one QCL property corresponds to at least one spatial QCL property. According to one or more embodiments of this aspect, the at least one RS is at least one downlink RS, the at least one downlink RS being one of a periodic, semi-persistent and aperiodic RS. A CSI report based on the TCI state update is transmitted where the report is one of a periodic, semi-persistent and aperiodic report.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of a wireless device relative to a network node and multiple beams transmitting different reference signals;

FIG. 2 is a signaling diagram of a TCI update procedure using MAC CE signaling;

FIG. 3 is a schematic diagram of an exemplary network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating exemplary methods implemented in a communication system including a host computer, a network node and a wireless device for executing a client application at a wireless device according to some embodiments of the present disclosure;

FIG. 6 is a flowchart illustrating exemplary methods implemented in a communication system including a host computer, a network node and a wireless device for receiving user data at a wireless device according to some embodiments of the present disclosure;

FIG. 7 is a flowchart illustrating exemplary methods implemented in a communication system including a host computer, a network node and a wireless device for receiving user data from the wireless device at a host computer according to some embodiments of the present disclosure;

FIG. 8 is a flowchart illustrating exemplary methods implemented in a communication system including a host computer, a network node and a wireless device for receiving user data at a host computer according to some embodiments of the present disclosure;

FIG. 9 is a flowchart of an example process in a network node according to some embodiments of the present disclosure;

FIG. 10 is a flowchart of another example process in a network node according to some embodiments of the present disclosure;

FIG. 11 is a flowchart of an example process in a wireless device according to some embodiments of the present disclosure; and

FIG. 12 is a flowchart of another example process in a wireless device according to some embodiments of the present disclosure.

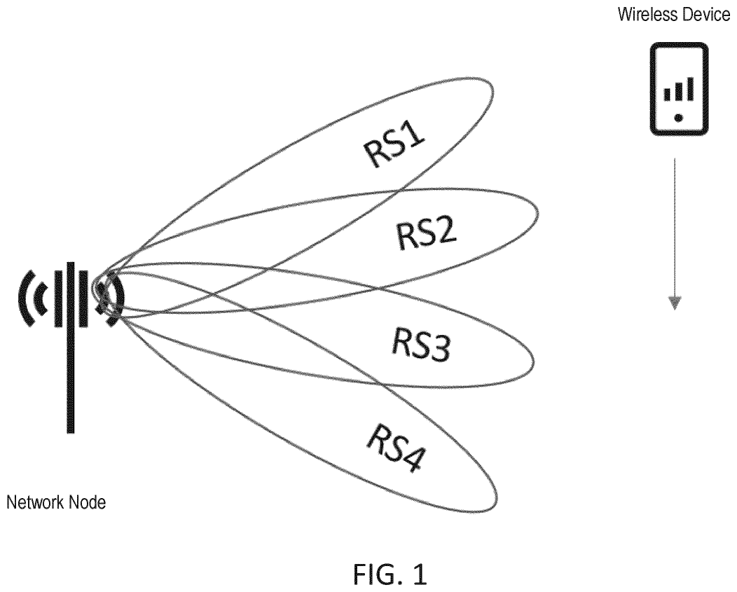

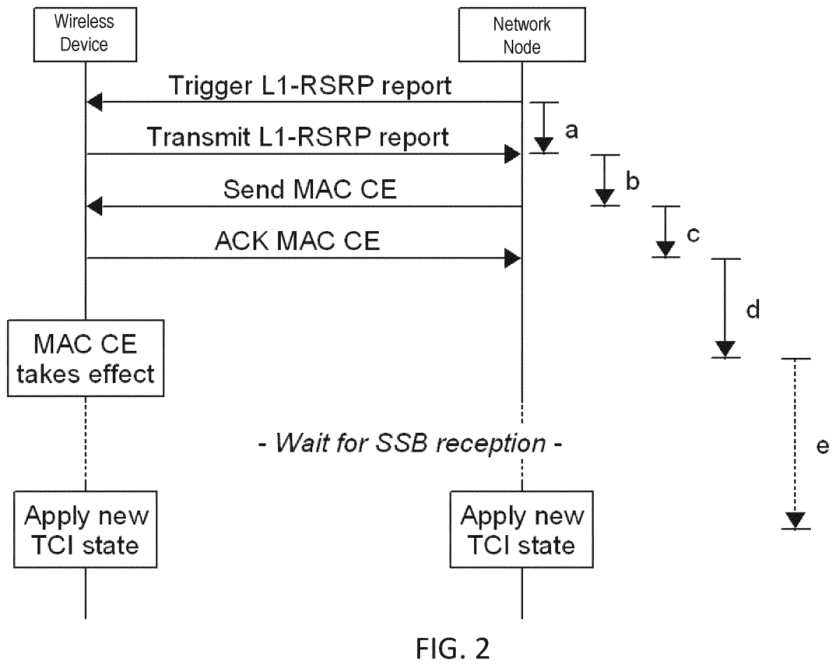

### DETAILED DESCRIPTION

In some systems, the wireless device may discard the QCL properties of an RS after a measurement as described above. To use the reference signals as a QCL source, the wireless device in these existing systems must perform another measurement on the reference signal. One or more embodiments described herein advantageously configures the wireless device to “remember” the QCL properties of a reference signal after performing a measurement of that signal. That is, the wireless device at least temporarily stores the QCL properties of a reference signal that was measured while a previous TCI state is active.

Before describing in detail exemplary embodiments, it is noted that the embodiments reside primarily in combinations of apparatus components and processing steps related to Transmission Configuration Indicator (TCI) state update based on at least one QCL property of a previous reference signal (RS) measurement (i.e., based on at least one RS being measured and reported while a previous TCI state is active).

Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices, and/or one or more bit patterns and/or other data representing the information.

Transmitting in downlink may pertain to transmission from the network or network node to the wireless device. Transmitting in uplink may pertain to transmission from the wireless device to the network or network node. Transmitting in sidelink may pertain to (direct) transmission from one wireless device to another. Uplink, downlink and sidelink (e.g., sidelink transmission and reception) may be considered communication directions. In some variants, uplink and downlink may also be used to described wireless communication between network nodes, e.g., for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

In some embodiments, a reference signal may refer to any downlink reference signal received for any purpose, whereas in other embodiments, a reference signal may refer to downlink reference signals associated with TCI states and/or Spatial Relation information.

In some embodiments, remembers the QCL properties may refer to remembering (i.e., at least temporarily storing) all QCL properties associated with the designated QCL Type, whereas in other embodiments, remembers the QCL properties may refer to remembering some of the properties associated with the designated QCL Type.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

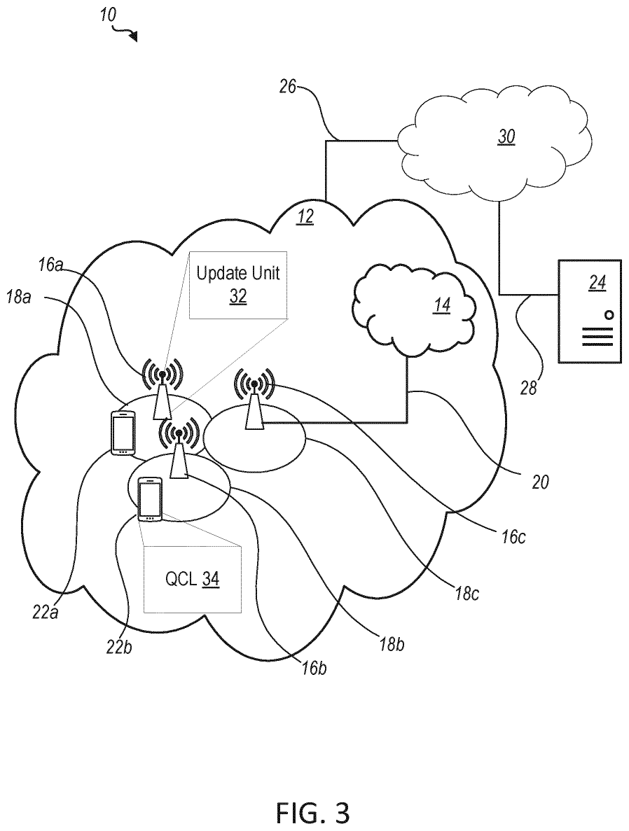

Embodiments provide TCI state update based on at least one QCL property of a previous RS measurement. Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an update unit 32 which is configured to perform one or more network node 16 functions as described herein such as with respect to TCI state update based on at least one QCL property of a previous RS measurement. A wireless device 22 is configured to include a QCL unit 34 which is configured to perform one or more wireless device 22 functions as described herein such as with respect to TCI state update based on at least one QCL property of a previous RS measurement (i.e., at least one QCL property of a measurement of at least one RS that was performed while a previous TCI state is active).

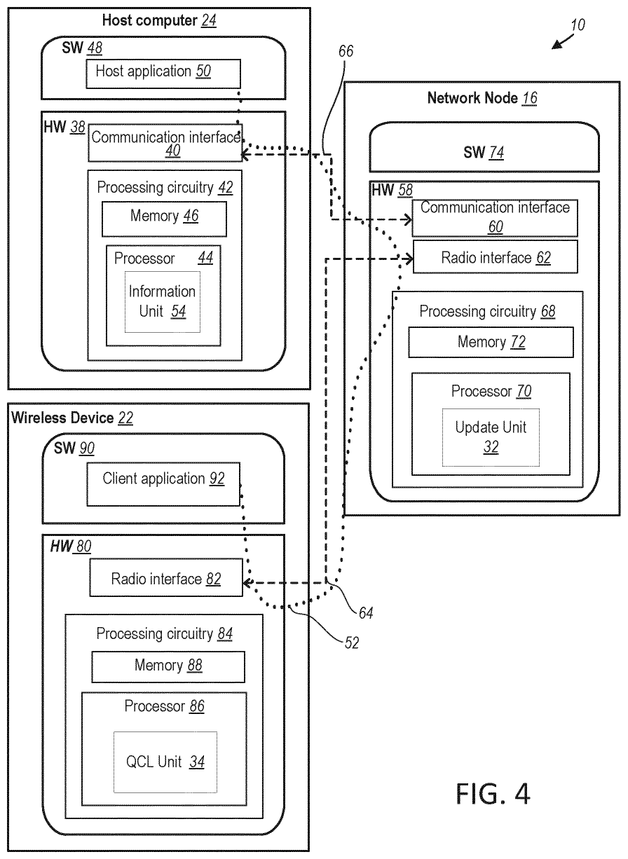

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to process, store, provide, transmit, receive, forward, analyze, etc., information related to TCI state update based on at least one QCL property of a previous RS measurement.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include update unit 32 configured to perform one or more network node 16 functions as described herein such as with respect to TCI state update based on at least one QCL property of a previous RS measurement.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a QCL unit 34 configured to perform one or more wireless device 22 functions as described herein such as with respect to TCI state update based on at least one QCL property of a previous RS measurement.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as update unit 32, and QCL unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

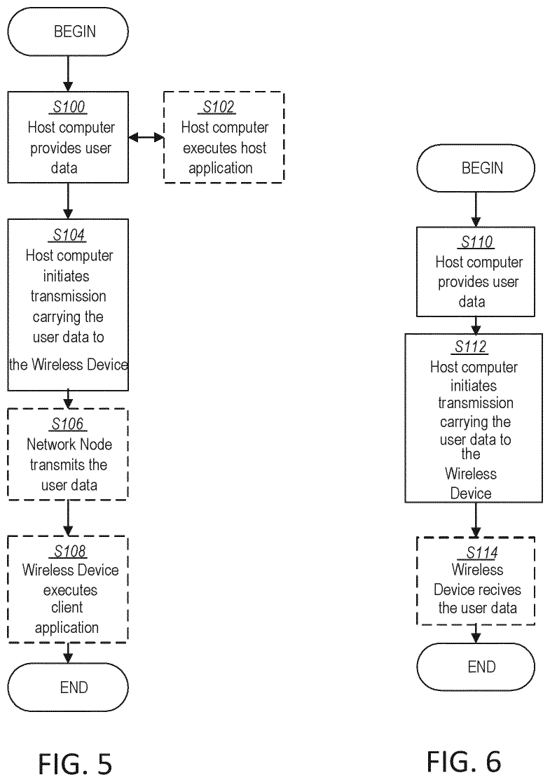

FIG. 5 is a flowchart illustrating an exemplary method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

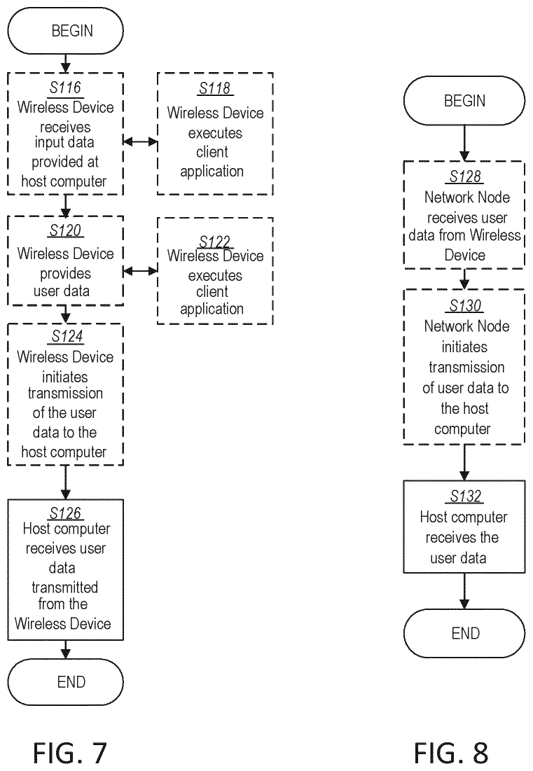

FIG. 7 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

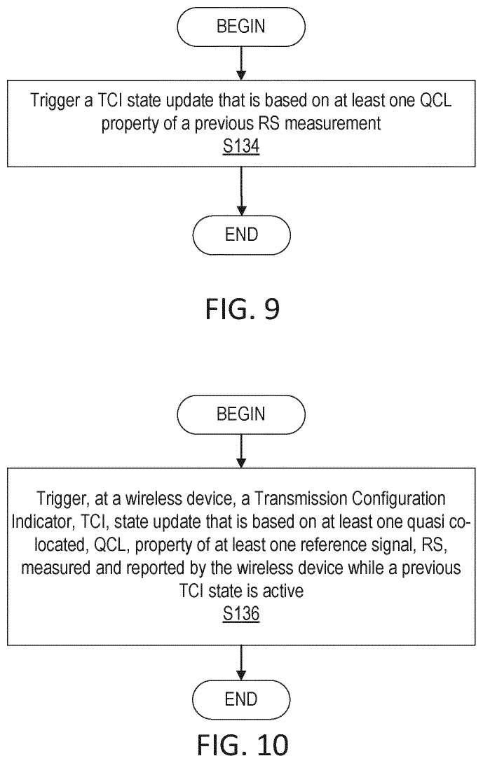

FIG. 9 is a flowchart of an exemplary process in a network node 16 according to some embodiments of the present disclosure. One or more Blocks and/or functions performed by network node 16 may be performed by one or more elements of network node 16 such as by update unit 32 in processing circuitry 68, processor 70, radio interface 62, etc. In one or more embodiments, network node 16 is configured to trigger (Block S134) a Transmission Configuration Indicator (TCI) state update that is based on at least one QCL property of a previous reference signal (RS) measurement, as described herein. In one or more embodiments, a TCI state update may correspond to switching to one or more beams of the network node 16.

According to one or more embodiments, the processing circuitry 68 is further configured to receive wireless device capability information indicating that the wireless device 22 is capable of storing information related to the at least one QCL property of the previous RS measurement, as described herein. According to one or more embodiments, the at least one QCL property includes at least one of power, at least one property associated with a channel state information, CSI, report, signal delay, doppler property and spatial property. According to one or more embodiments, the RS is a downlink RS associated with at least one of a TCI state and spatial relation information where the RS is one of a periodic, semi-persistent and aperiodic RS. The processing circuitry is configured to receive a CSI report based on the TCI state update where the report is one of a periodic, semi-persistent and aperiodic report.

FIG. 10 is a flowchart of another example of a process in a network node 16 according to some embodiments of the present disclosure. One or more Blocks and/or functions performed by network node 16 may be performed by one or more elements of network node 16 such as by update unit 32 in processing circuitry 68, processor 70, radio interface 62, etc. In one or more embodiments, network node 16 is configured to trigger (Block S136), at a wireless device 22, a Transmission Configuration Indicator, TCI, state update that is based on at least one quasi co-located, QCL, property of at least one reference signal, RS, measured and reported by the wireless device 22 while a previous TCI state is active, as described herein.

According to one or more embodiments, the triggering of the TCI state update is associated with the wireless device applying an updated TCI state. According to one or more embodiments, the applying of the updated TCI state is configured to occur without having to wait for an occurrence of a reference signal associated with the updated TCI state. According to one or more embodiments, the processing circuitry 68 is further configured to receive wireless device capability information indicating that the wireless device 22 is capable of storing information related to the at least one QCL property of at least one RS measurement.

According to one or more embodiments, the at least one QCL property includes at least one of power, at least one property associated with a channel state information, CSI, report, signal delay, doppler property and spatial property. According to one or more embodiments, the at least one RS is at least one downlink RS, the at least one downlink RS being one of a periodic, semi-persistent and aperiodic RS, and the processing circuitry is further configured to receive a channel state information, CSI, report based on the TCI state update, the report being one of a periodic, semi-persistent and aperiodic report, as described herein.

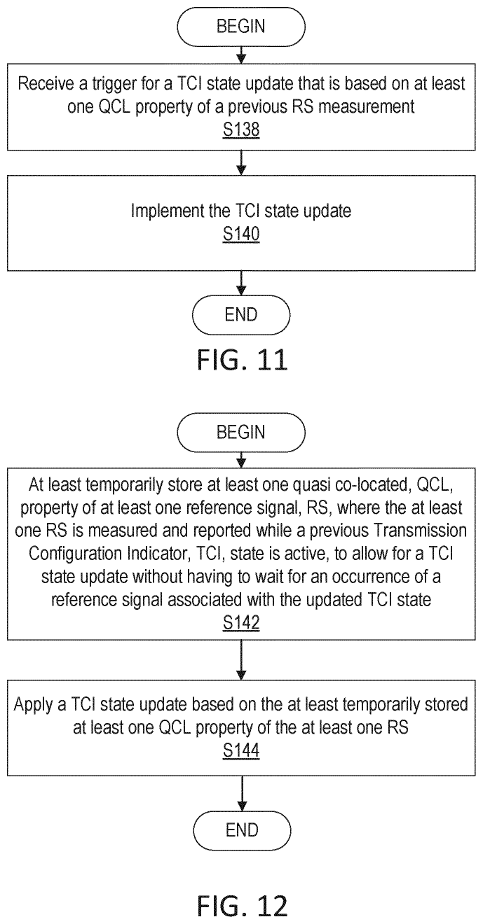

FIG. 11 is a flowchart of an example process in a wireless device 22 according to some embodiments of the present disclosure. One or more Blocks and/or functions performed by wireless device 22 may be performed by one or more elements of wireless device 22 such as by QCL unit 34 in processing circuitry 84, processor 86, radio interface 82, etc. In one or more embodiments, wireless device 22 is configured to receive (Block S138) a trigger for a Transmission Configuration Indicator (TCI) state update that is based on at least one QCL property of a previous reference signal (RS) measurement, as described herein. In one or more embodiments, wireless device 22 is configured to implement (Block S140) the TCI state update, as described herein.

According to one or more embodiments, the processing circuitry 84 is further configured to transmit wireless device capability information indicating that the wireless device 22 is capable of storing information related to the at least one QCL property of the previous RS measurement. According to one or more embodiments, the at least one QCL property includes at least one of power, at least one property associated with a channel state information, CSI, report, signal delay, doppler property and spatial property. According to one or more embodiments, the RS is a downlink RS associated with at least one of a TCI state and spatial relation information, the RS being one of a periodic, semi-persistent and aperiodic RS. The processing circuitry 84 is configured to transmit a CSI report based on the TCI state update where the report is one of a periodic, semi-persistent and aperiodic report. In one or more embodiments, the TCI update may be signaled using MAC CE signaling as described herein but where the MAC CE takes effect faster such as by using at least one QCL property of the previous RS measurement.

FIG. 12 is a flowchart of another example process in a wireless device 22 according to some embodiments of the present disclosure. One or more Blocks and/or functions performed by wireless device 22 may be performed by one or more elements of wireless device 22 such as by QCL unit 34 in processing circuitry 84, processor 86, radio interface 82, etc. In one or more embodiments, wireless device 22 is configured to at least temporarily store (Block S142) at least one quasi co-located, QCL, property of at least one reference signal, RS, the at least one RS being measured and reported while a previous Transmission Configuration Indicator (TCI) state is active, to allow for a TCI state update without having to wait for an occurrence of a reference signal associated with the updated TCI state, as described herein. In one or more embodiments, wireless device 22 is configured to apply (Block S144) a TCI state update based on the at least temporarily stored at least one QCL property of the at least one RS, as described herein.

According to one or more embodiments, the at least one QCL property of a plurality of QCL properties associated with the at least one RS is based on a QCL type of the at least one RS. According to one or more embodiments, the at least temporarily storing of the at least one QCL property corresponds to storing of the at least one QCL property for a predefined quantity of time. According to one or more embodiments, the at least one RS is a plurality of RSs, the at least one QCL property corresponds to a plurality of QCL properties for the plurality of RSs that were measured and reported while the previous TCI is active.

According to one or more embodiments, the at least temporarily storing of at least one QCL property associated with the at least one RS is based on a time domain behavior of at least the at least one RS. According to one or more embodiments, the processing circuitry 84 is further configured receive a channel state information, CSI, report configuration indicating QCL properties of at least one RS measurement to be reported. According to one or more embodiments, the processing circuitry 84 is further configured to transmit wireless device capability information indicating that the wireless device 22 is capable of storing information related to the at least one QCL property of the at least one RS that is measured and reported while the previous TCI state is active.

According to one or more embodiments, the at least one QCL property includes at least one of power, at least one property associated with a channel state information, CSI, report, signal delay, doppler property and spatial property. According to one or more embodiments, the at least one QCL property corresponds to at least one spatial QCL property. According to one or more embodiments, the at least one RS is at least one downlink RS, the at least one downlink RS being one of a periodic, semi-persistent and aperiodic RS where the processing circuitry is configured to transmit a CSI report based on the TCI state update where the report is one of a periodic, semi-persistent and aperiodic report.

Having generally described arrangements for TCI state update based on at least one QCL property of a previous RS measurement, details for these arrangements, functions and processes are provided as follows, and which may be implemented by the network node 16, wireless device 22 and/or host computer 24. One or more wireless device 22 functions described below may be performed by one or more of processing circuitry 84, processor 86, radio interface 82, QCL unit 34, etc. One or more network node 16 functions described below may be performed by one or more of processing circuitry 68, processor 70, update unit 32, radio interface 62, etc.

Embodiments provide for a TCI state update based on at least one QCL property of a previous RS measurement. That is, the TCI state update is based on at least one QCL property of an RS that was measured and reported while a previous TCI state is active. As described above, the wireless device 22 may discard the QCL properties of a reference signal after a measurement. To use the reference signals as a QCL source in these existing systems, the wireless device 22 must perform another measurement on the reference signal. However, the instant disclosure provides enhancements to existing systems, and thereby addresses one or more issues with existing systems as described below.

In a preferred embodiment, the wireless device 22 remembers the QCL properties of a reference signal after performing a measurement on that signal such as while a previous TCI state is active.

In another embodiment, the wireless device 22 remembers (e.g., at least temporarily store) the QCL properties of all reference signals that wireless device 22 performed measurements on, and reported measured values for, during a certain time period. For instance, the wireless device 22 may remember the QCL properties from the latest (e.g., previous) measurement on a reference signal for some prior determined time counting/time period, e.g., from the latest transmission of the reference signal (measurement opportunity) or from the latest reporting of a measurement on the reference signal. As non-limiting examples, the prior determined time may for instance be a time expressed as 3 seconds (s), 4 s, or 1280 ms. The prior determined time may be different for different wireless devices 22 power classes and for different frequency ranges. The prior determined time may additionally depend on a reported wireless device 22 capability.

In another embodiment, the wireless device 22 remembers (e.g., has stored in memory 88) the QCL properties for a subset of the reference signals that the wireless device 22 has performed measurements on and reported measured values for. The wireless device 22 remembers the QCL properties for the N≥1 reference signals associated with, for instance, the strongest measured and reported reference signal strengths, e.g., L1-RSRP. Other metrics than signal strength may be used for ranking for subset inclusion. N may or may not include reference signals associated with active TCI states for PDSCH. If N includes reference signals associated with active TCI states, then N is larger than the number of active TCI states. Non-limiting example values of N are N=2 or 3 when the wireless device 22 is capable of one active TCI state, and active TCI states are included in N, thus allowing for the wireless device 22 to maintain information on 1 or 2 candidates for active TCI states. Other nonlimiting example values of N are N=4 or 5 are when the wireless device 22 is capable of two active TCI states, and active TCI states are included in N, thus allowing for maintaining information on 2 or 3 candidates for active TCI states. The value of N may be different for different for different frequency ranges. The value of N may further be specified in a standard specification, or may depend on a reported capability.

In another embodiment, the wireless device 22 remembers the QCL properties for a subset of the reference signals it has performed measurements on, and reported measured values for, during a certain time period. This embodiment is a combination of the previous two embodiments.

As mentioned above, NR supports three time-domain behaviors of CSI-RS transmissions: periodic, semi-persistent and aperiodic. In one embodiment, the wireless device 22 may remember the QCL properties only for reference signals with a certain time-domain behavior. For example, the wireless device 22 may only remember QCL properties of aperiodic reference signals.

The wireless device 22 can be configured such as by network node 16 with several different measurement reports, in a so-called CSI report configuration. The report configuration contains the properties of the measurement that the wireless device 22 may report, including the properties of the reference signal that the wireless device 22 may perform measurements on. Each report configuration may be identified by a unique Identifier (ID).

In one embodiment, the wireless device 22, remembers the QCL properties of a reference signal associated with a certain CSI report configuration. For example, the network node 16 may configure the wireless device 22 to only remember the QCL properties of the reference signals associated with CSI report config 5.

Further, as previously discussed, NR supports three time-domain behaviors of the reporting: periodic, semi-persistent and aperiodic reporting. In one embodiment, the wireless device 22 remembers the QCL properties only for reference signals associated with one time-domain behavior. For example, the wireless device 22 may only remember QCL properties of reference signals associated with aperiodic reporting.

In one or more embodiments, derived from the ones above, the wireless device 22 remembers the QCL Type C properties. In yet another set of embodiments derived from the ones above, the wireless device 22 remembers the QCL Type C and QCL Type D properties.

In some situations, even though the wireless device 22 remembers the QCL properties of a reference signal for a previous measurement may not automatically lead to that the network node 16 being able to update the TCI state faster as the network node 16 may be required to know that the wireless device 22 has this ability. This type of capability information can be signaled as part of the wireless device 22 capability signaling, where the wireless device 22 informs the network node 16 about its capabilities. Signaling of the capability related to storage or “remembering” QCL is a new feature that is not provided in existing system.

In another set of embodiments, the wireless device 22 may signal to the network node 16 that it is capable of remembering some or all QCL properties of a reference signal from a previous measurement (i.e., measurement(s) performed and reported while a previous TCI state is active).

### EXAMPLES

Example A1. A network node 16 configured to communicate with a wireless device 22 (WD 22), the network node 16 configured to, and/or comprising a radio interface 62 and/or comprising processing circuitry 68 configured to:

trigger a Transmission Configuration Indicator (TCI) state update that is based on at least one QCL property of a previous reference signal (RS) measurement.

Example A2. The network node 16 of Example A1, wherein the network node 16 and/or the radio interface 62 and/or the processing circuitry 68 is further configured to receive wireless device capability information indicating that the wireless device 22 is capable of storing information related to the at least one QCL property of the previous RS measurement.

Example A3. The network node 16 of Example A1, wherein the at least one QCL property includes at least one of power, at least one property associated with a channel state information, CSI, report, signal delay, doppler property and spatial property.

Example A4. The network node 16 of Example A1, wherein the RS is a downlink RS associated with at least one of a TCI state and spatial relation information, the RS being one of a periodic, semi-persistent and aperiodic RS; and the network node 16 and/or the radio interface and/or the processing circuitry 68 is configured to receive a CSI report based on the TCI state update, the report being one of a periodic, semi-persistent and aperiodic report.

Example B1. A method implemented in a network node 16, the method comprising triggering a Transmission Configuration Indicator (TCI) state update that is based on at least one QCL property of a previous reference signal (RS) measurement.

Example B2. The method of Example B1, further comprising receiving wireless device capability information indicating that the wireless device 22 is capable of storing information related to the at least one QCL property of the previous RS measurement.

Example B3. The method of Example B1, wherein the at least one QCL property includes at least one of power, at least one property associated with a channel state information, CSI, report, signal delay, doppler property and spatial property.

Example B4. The method of Example B1, wherein the RS is a downlink RS associated with at least one of a TCI state and spatial relation information, the RS being one of a periodic, semi-persistent and aperiodic RS; and the method further comprising receiving a CSI report based on the TCI state update, the report being one of a periodic, semi-persistent and aperiodic report.

Example C1. A wireless device 22 (WD 22) configured to communicate with a network node 16, the WD 22 configured to, and/or comprising a radio interface 62 and/or processing circuitry 68 configured to:
receive a trigger for a Transmission Configuration Indicator (TCI) state update that is based on at least one QCL property of a previous reference signal (RS) measurement; and
implement the TCI state update.

Example C2. The wireless device 22 of Example C1, wherein the wireless device 22 and/or the radio interface 82 and/or the processing circuitry 84 is further configured to transmit wireless device capability information indicating that the wireless device 22 is capable of storing information related to the at least one QCL property of the previous RS measurement.

Example C3. The wireless device 22 of Example C1, wherein the at least one QCL property includes at least one of power, at least one property associated with a channel state information, CSI, report, signal delay, doppler property and spatial property.

Example C4. The wireless device 22 of Example C1, wherein the RS is a downlink RS associated with at least one of a TCI state and spatial relation information, the RS being one of a periodic, semi-persistent and aperiodic RS; and the processing circuitry 84 is configured to transmit a CSI report based on the TCI state update, the report being one of a periodic, semi-persistent and aperiodic report.

Example D1. A method implemented in a wireless device 22 (WD 22), the method comprising:
receiving a trigger for a Transmission Configuration Indicator (TCI) state update that is based on at least one QCL property of a previous reference signal (RS) measurement; and
implementing the TCI state update.

Example D2. The method of Example D1, further comprising transmitting wireless device capability information indicating that the wireless device 22 is capable of storing information related to the at least one QCL property of the previous RS measurement.

Example D3. The method of Example D1, wherein the at least one QCL property includes at least one of power, at least one property associated with a channel state information, CSI, report, signal delay, doppler property and spatial property.

Example D4. The method of Example D1, wherein the RS is a downlink RS associated with at least one of a TCI state and spatial relation information, the RS being one of a periodic, semi-persistent and aperiodic RS; and
further comprising transmitting a CSI report based on the TCI state update, the report being one of a periodic, semi-persistent and aperiodic report.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-6. (canceled)

7. A method implemented by a network node that is configured to communicate with a wireless device, the method comprising:
triggering, at a wireless device, a Transmission Configuration Indicator, TCI, state update that is based on at least one quasi co-located, QCL, property of at least one reference signal, RS, measured and reported by the wireless device while a previous TCI state is active.

8.-12. (canceled)

13. A wireless device comprising:
processing circuitry configured to:
at least temporarily store at least one quasi co-located, QCL, property of at least one reference signal, RS, the at least one RS being measured and reported while a previous Transmission Configuration Indicator, TCI, state is active, to allow for a TCI state update without having to wait for an occurrence of a reference signal associated with the updated TCI state; and
apply a TCI state update based on the at least temporarily stored at least one QCL property of the at least one RS.

14. The wireless device of claim 13, wherein the at least one QCL property of a plurality of QCL properties associated with the at least one RS is based on a QCL type of the at least one RS.

15. The wireless device of claim 13, wherein the at least temporarily storing of the at least one QCL property corresponds to storing of the at least one QCL property for a predefined quantity of time.

16. The wireless device of claim 13, wherein the at least one RS is a plurality of RSs, the at least one QCL property corresponds to a plurality of QCL properties for the plurality of RSs that were measured and reported while the previous TCI is active.

17. The wireless device of claim 13, wherein the at least temporarily storing of at least one QCL property associated with the at least one RS is based on a time domain behavior of at least the at least one RS.

18. The wireless device of claim 13, wherein the processing circuitry is further configured receive a channel state information, CSI, report configuration indicating QCL properties of at least one RS measurement to be reported.

19. The wireless device of claim 13, wherein the processing circuitry is further configured to transmit wireless device capability information indicating that the wireless device is capable of storing information related to the at least one QCL property of the at least one RS that is measured and reported while the previous TCI state is active.

20. The wireless device of claim 13, wherein the at least one QCL property includes at least one of power, at least one property associated with a channel state information, CSI, report, signal delay, doppler property and spatial property.

21. The wireless device of claim 13, wherein the at least one QCL property corresponds to at least one spatial QCL property.

22. The wireless device of claim 13, wherein the at least one RS is at least one downlink RS, the at least one downlink RS being one of a periodic, semi-persistent and aperiodic RS; and
the processing circuitry is configured to transmit a CSI report based on the TCI state update, the report being one of a periodic, semi-persistent and aperiodic report.

23. A method implemented by a wireless device, the method comprising:
at least temporarily storing at least one quasi co-located, QCL, property of at least one reference signal, RS, the at least one RS being measured and reported while a previous Transmission Configuration Indicator, TCI, state is active, to allow for a, TCI, state update without having to wait for an occurrence of a reference signal associated with an updated TCI state; and
applying a TCI state update based on the at least temporarily stored at least one QCL property of the at least one RS.

24. The method of claim 23, wherein the at least one QCL property of a plurality of QCL properties associated with the at least one RS is based on a QCL type of the at least one RS.

25. The method of claim 23, wherein the at least temporarily storing of the at least one QCL property corresponds to storing of the at least one QCL property for a predefined quantity of time.

26. The method of claim 23, wherein the at least one RS is a plurality of RSs, the at least one QCL property corresponds to a plurality of QCL properties for the plurality of RSs that were measured and reported while the previous TCI is active.

27. The method of claim 23, wherein the at least temporarily storing of at least one QCL property associated with the at least one RS is based on a time domain behavior of at least the at least one RS.

28. The method of claim 23, further comprising receiving a channel state information, CSI, report configuration indicating QCL properties of at least one RS measurement to be reported.

29. The method of claim 23, further comprising transmitting wireless device capability information indicating that the wireless device is capable of storing information related to the at least one QCL property of the at least one RS that is measured and reported while the previous TCI state is active.

30. The method of claim 23, wherein the at least one QCL property includes at least one of power, at least one property associated with a channel state information, CSI, report, signal delay, doppler property and spatial property.

31. The method of claim 23, wherein the at least one QCL property corresponds to at least one spatial QCL property.

32. The method of claim 23, wherein the at least one RS is at least one downlink RS, the at least one downlink RS being one of a periodic, semi-persistent and aperiodic RS; and
the method further comprising transmitting a CSI report based on the TCI state update, the report being one of a periodic, semi-persistent and aperiodic report.
